(19) United States
(12) Patent Application Publication
(10) Pub. No.: US 2013/0130024 A1
(43) Pub. Date: May 23, 2013

(54) RELEASE AGENT COMPOSITION, RELEASE SHEET, AND PRESSURE-SENSITIVE ADHESIVE BODY

(71) Applicants: Masami Yamaguchi, Saitama (JP); Ryo Takahashi, Saitama (JP); Yudai Suzuki, Mie (JP)

(72) Inventors: Masami Yamaguchi, Saitama (JP); Ryo Takahashi, Saitama (JP); Yudai Suzuki, Mie (JP)

(21) Appl. No.: 13/812,866

(22) PCT Filed: Aug. 3, 2011
(86) PCT No.: PCT/JP2011/067735

§ 371 Date: Jan. 29, 2013

(30) Foreign Application Priority Data
Aug. 11, 2010 (JP) 2010 180428

(51) Int. Cl. C08L 33/08; C09J 7/02

(52) U.S. Cl. CPC C08L 33/08; C09J 7/0225
USPC 428/336; 525/186; 428/352

(57) ABSTRACT

A release agent composition according to the present invention comprises a polyester resin (A), an acrylic-based polymer (B) containing a constitutional unit represented by the following general formula (1), and a cross-linking agent (C). When the amount of the polyester resin (A) blended is expressed as A parts by mass, and the amount of the acrylic-based polymer (B) blended is expressed as B parts by mass, the mass ratio A/B is 50/50 to 95/5.

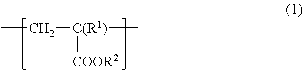

In general formula (1), R¹ represents a hydrogen atom or a methyl group and R² represents an alkyl group having 12 to 16 carbon atoms.

### TECHNICAL FIELD

The present invention relates to a release agent composition, a release sheet, and a pressure-sensitive adhesive body; and specifically to a release agent composition, a release sheet, and a pressure-sensitive adhesive body which are non-silicone-based and are used in applications with electrical parts.

### BACKGROUND ART

Electrical parts such as relays, switches, connectors, motors, and hard disks have been widely used in various products. Pressure-sensitive adhesive sheets may be attached to these electrical parts temporarily to secure them in place during assembly, display of contents, etc. In general, a pressure-sensitive adhesive sheet comprises a pressure-sensitive adhesive sheet substrate and a pressure-sensitive adhesive layer provided on the substrate. Until it is attached to an adherend such as an electrical part, the pressure-sensitive adhesive layer is preserved by remaining attached to a release sheet, in general.

A release layer is provided on a surface (namely, a surface to be in contact with a pressure-sensitive adhesive layer) of the release sheet in order to improve the releasability when the release sheet is peeled away. A silicone resin is ordinarily used as a constituent material of the release layer (for example, see Patent Literature 1).

However, in the case of a release sheet using a silicone resin, a silicone compound such as a low molecular-weight silicone resin, a siloxane, or a silicone oil in the release layer may migrate to the pressure-sensitive adhesive layer. In addition, the release sheet is wound up into a rolled form after manufacturing. At this time, the back surface of the release sheet and the release layer are brought into contact with each other, and the silicone compound in the release layer may migrate also to the back surface of the release sheet. The silicone compound having migrated to the back surface of the release sheet may further migrate to a pressure-sensitive adhesive sheet substrate when the release sheet is attached to a pressure-sensitive adhesive sheet and the sheets are wound up in a rolled form.

The silicone compound having migrated to the pressure-sensitive adhesive layer or the pressure-sensitive adhesive sheet substrate may gradually vaporize, and in a case where the pressure-sensitive adhesive sheet is peeled from the release sheet and attached to an adherend such as an electrical component. The vaporized silicone compound could become deposited on a surface of an electrical contact portion of the electrical component because of an arc generated near the electrical contact portion, for example. If silicone deposits cause a thin layer of silicone compound to form on an electrical contact, it could degrade the electrical conductivity of the electrical part. And when the pressure-sensitive adhesive sheet is attached to a hard disk device, the vaporized silicone compound may be deposited on a magnetic head, a disk surface, or the like, which could cause a read/write failure of the hard disk.

To solve the problem of silicone contamination, the development of so-called non-silicone-based release agents such as olefin resin-based release agents and long-chain alkyl-based release agents, which do not contain silicone compounds, has been advanced to date (for example, see Patent Literature references 2 and 3). However, these non-silicone-based release agents are poor in terms of heat resistance, and hence make it difficult to establish a pressure-sensitive adhesive layer by directly applying a pressure-sensitive adhesive agent onto the release layer and then thermally drying the pressure-sensitive adhesive agent. Moreover, the release sheets using non-silicone-based release agents also have problems with blocking occurring between surfaces of the release sheet, which tends to happen in the unwinding of release sheets using non-silicone-based release agents after being wound up in a rolled form during storage.

### CITATION LIST

### Related Patent Literature

Patent Literature 1: Japanese Patent Application Publication No. Hei 6-336574
Patent Literature 2: Japanese Patent Application Publication No. 2005-350650
Patent Literature 3: Japanese Patent Application Publication No. Hei 5-295332

### SUMMARY OF THE INVENTION

### Technical Problems

The present invention has been made in view of the above-described problems, and an object of the present invention is to provide a release agent composition, a release sheet, and a pressure-sensitive adhesive body that do not adversely affect electrical parts and the like, that make it possible to reduce the possibility of blocking occurring between both surfaces of the release sheet when the release sheet is wound up in a rolled form during storage, and that further provide excellent releasability and heat resistance.

### Solution to Problems

A release agent composition according to the present invention comprises:

a polyester resin (A);

an acrylic-based polymer (B) containing a constitutional unit represented by the following general formula (1); and

a cross-linking agent (C); wherein

when the amount of the polyester resin (A) blended is expressed as A parts by mass, and the amount of the acrylic-based polymer (B) blended is expressed as B parts by mass, the mass ratio A/B is in a range from 50/50 to 95/5:

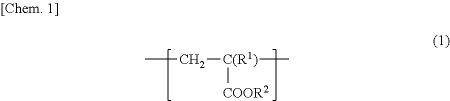

(In general formula (1), R¹ represents a hydrogen atom or a methyl group, and R² represents an alkyl group having 12 to 16 carbon atoms).

The acrylic-based polymer (B) preferably further contains a constitutional unit having a functional group selected from the group consisting of a hydroxyl group, an amino group, and a carboxyl group.

The polyester resin (A) has a number average molecular weight of, for example, 500 to 10,000, and the acrylic-based polymer (B) has amass average molecular weight of, for example, 70,000 to two million. Moreover, the polyester resin (A) preferably has a hydroxyl group as a functional group.

The cross-linking agent (C) is preferably a multifunctional amino compound, a multifunctional isocyanate compound, a multifunctional epoxy compound, or a multifunctional metal compound. In addition, the amount of the cross-linking agent (C) blended is preferably 1 to 30 parts by mass relative to 100 parts by mass, which is the total amount of the polyester resin (A) and the acrylic-based polymer (B). The release agent composition preferably does not contain any substantial amount of silicone compound.

A release sheet according to the present invention comprises a substrate and a release layer, which is provided on the substrate and made of a cured product of the above-described release agent composition. Here, the release layer has a thickness of 50 nm to 2 μm, for example.

A pressure-sensitive adhesive body according to the present invention comprises the above-described release sheet and a pressure-sensitive adhesive layer, which is provided on the release layer of the release sheet and which contains substantially no silicone compound.

### Advantageous Effects of the Invention

The present invention makes it possible to provide a release agent composition, a release sheet, and a pressure-sensitive adhesive body that do not adversely affect electrical parts and the like, while providing excellent anti-blocking characteristics, releasability, and heat resistance.

### DESCRIPTION OF THE EMBODIMENTS

Hereinafter, the present invention will be described in further detail on the basis of several different embodiments.

A release agent composition of one embodiment of the present invention comprises a polyester resin (A), an acrylic-based polymer (B), and a cross-linking agent (C).

The polyester resin (A) is not particularly limited, and a polyester resin selected as appropriate from any known polyester resins can be used. Specific examples of the polyester resin are resins obtained by condensation reaction of a polyvalent alcohol and a polybasic acid, including nonconvertible polyester resins such as condensates of a dibasic acid and a divalent alcohol, polyester resins modified with a nondrying oil fatty acid or the like, convertible polyester resins such as condensates of a dibasic acid and a tri- or higher-valent alcohol, and so on. Any of these polyester resins can be used in the present invention.

Examples of the polyvalent alcohol used as a raw material of the polyester resin include divalent alcohols such as ethylene glycol, diethylene glycol, triethylene glycol, propylene glycol, trimethylene glycol, tetramethylene glycol, and neopentyl glycol; trivalent alcohols such as glycerin, trimethylolethane, and trimethylolpropane; and polyvalent alcohols having a valence of 4 or higher such as diglycerin, triglycerin, pentaerythritol, dipentaerythritol, mannite, and sorbit. One of these polyvalent alcohols may be used alone, or two or more thereof may be used in combination.

Meanwhile, examples of the polybasic acid include aromatic polybasic acids such as phthalic anhydride, terephthalic acid, isophthalic acid, and trimellitic anhydride; aliphatic saturated polybasic acids such as succinic acid, adipic acid, and sebacic acid; aliphatic unsaturated polybasic acids such as maleic acid, maleic anhydride, fumaric acid, itaconic acid, and citraconic anhydride; polybasic acids based on the Diels-Alder reaction such as cyclopentadiene-maleic anhydride adduct, terpene-maleic anhydride adduct, and rosin-maleic anhydride adduct; and the like. One of these polybasic acids may be used alone, or two or more thereof may be used in combination.

Further, examples of the nondrying oil fatty acid or the like, which is a modifying agent, include octanoic acid, lauric acid, palmitic acid, stearic acid, oleic acid, linoleic acid, linoleinic acid, eleostearic acid, ricinoleic acid, and ricinoleic, as well as coconut oil, linseed oil, tung oil, castor oil, dehydrated castor oil, soybean oil, and safflower oil, and fatty acids thereof, and the like. One of these nondrying oil fatty acids and the like may be used alone, or two or more thereof may be used in combination. Moreover, one of the resultant polyester resins may be used alone or two or more thereof may be used in combination.

The polyester resin (A) preferably has a reactive functional group for a reaction with the cross-linking agent (C), and the reactive functional group is more preferably a hydroxyl group. In addition, the hydroxyl value of the polyester resin (A) is preferably 5 to 500 mgKOH/g, and more preferably 10 to 300 mgKOH/g.

Moreover, the number average molecular weight of the polyester resin (A) is preferably 500 to 10,000, and more preferably 1000 to 5000. Since the polyester resin (A) has a relatively low number average molecular weight as stated here, a network structure formed when the release agent composition is cross-linked by the cross-linking agent (C) tends to be dense, and the acrylic-based polymer (B) tends to segregate toward a release surface described later.

The acrylic-based polymer (B) contains a constitutional unit represented by the following general formula (1):

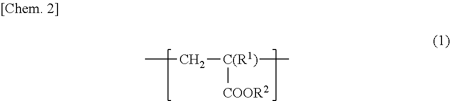

(In general formula (1), R¹ represents a hydrogen atom or a methyl group, and R² represents an alkyl group having 12 to 16 carbon atoms).

If the number of the carbon atoms in the alkyl group R² is less than 12, it is difficult for the acrylic-based polymer (B) to exhibit good mold releasability, in general. Meanwhile, if the number of the carbon atoms exceeds 16, the release force becomes excessive because of the increase in crystallinity and the like, which reduces the releasability of the release agent. For these reasons, the release agent has excellent releasability when the acrylic-based polymer (B) has a long-chain alkyl group having 12 to 16 carbon atoms. Note that for obtaining favorable releasability, R² in general formula (1) is preferably a linear alkyl group, and the number of carbon atoms in R² is preferably 12 to 14.

Examples of the monomer for forming the constitutional unit of general formula (1) include (meth)acrylic acid esters whose ester moieties are long-chain alkyl groups having 12 to 16 carbon atoms, and specific examples thereof include lauryl (meth)acrylate, myristyl (meth)acrylate, palmityl (meth)acrylate, and the like. One of these monomers may be used alone, or two or more thereof may be used in combination.

The content of the constitutional unit represented by general formula (1) in the acrylic-based polymer (B) is preferably 80% by mass or higher, more preferably 90% by mass or higher, and ideally 95% by mass or higher.

The acrylic-based polymer (B) may contain a constitutional unit derived from a vinyl monomer containing a reactive functional group for a reaction with the cross-linking agent (C). In this case, the content of the constitutional unit derived from a vinyl monomer containing a reactive functional group in the acrylic-based polymer (B) is preferably 0.01% to 20% by mass, more preferably 0.1% to 10% by mass, and ideally 0.2% to 5% by mass. Here, examples of the reactive functional group include a hydroxyl group, an amino group, a carboxyl group, a thiol group, and the like. One kind of these reactive functional groups may be contained alone, or two or more kinds thereof may be contained in combination. Of these functional groups, a hydroxyl group, an amino group, or a carboxyl group is preferable. Moreover, when the acrylic-based polymer (B) contains the constitutional unit derived from a vinyl monomer having a reactive functional group, the primary structure of the acrylic-based polymer (B) may be a random copolymer or a block copolymer.

The release force of the release agent with respect to a pressure-sensitive adhesive agent can be controlled by using a vinyl monomer having a reactive functional group as described above. For example, for applications where release with weak force is required, a release agent enabling the release with weak force can be obtained by lowering the ratio of the vinyl monomer having a reactive functional group.

Examples of the above-described vinyl monomer containing a reactive functional group include (meth)acrylic esters including hydroxyl group-containing (meth)acrylates such as hydroxyethyl (meth)acrylate, hydroxypropyl (meth)acrylate, and hydroxybutyl (meth)acrylate; carboxyl group-containing (meth)acrylates such as 1,4-di(meth)acryloxyethyl pyromellitate, 4-(meth)acryloxyethyl trimellitate, and 2-(meth)acryloyloxybenzoic acid; primary or secondary amino group-containing (meth)acrylates such as aminoethyl (meth)acrylate, ethylaminoethyl (meth)acrylate, aminopropyl (meth)acrylate, and ethylaminopropyl (meth)acrylate; and thiol group-containing (meth)acrylates such as 2-(methylthio)ethyl methacrylate; and the like, as well as acrylic monomers other than (meth)acrylic esters such as N-(meth) acryloyl-p-aminobenzoic acid, N-(meth) acryloyl-5-aminosalicylic acid, acrylic acid, and methacrylic acid. One of these vinyl monomers may be used alone, or two or more thereof may be used in combination.

Moreover, the acrylic-based polymer (B) may contain a constitutional unit represented by the following general formula (2), in addition to the above-described constitutional units. The content of the constitutional unit represented by general formula (2) in the acrylic-based polymer (B) is 0 to 20% by mass:

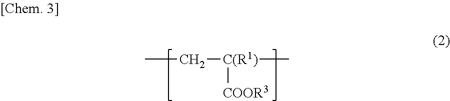

(In general formula (2), R¹ represents a hydrogen atom or a methyl group, and R³ represents an alkyl group having 1 to 11 carbon atoms, provided that the alkyl group may contain a fluorine atom, an oxygen atom, or a nitrogen atom).

The mass average molecular weight of the acrylic-based polymer (B) is preferably 70,000 to 2 million and more preferably 90,000 to 1 million. By setting the mass average molecular weight within this range, segregation of the acrylic-based polymer (B) on a release surface described later is more likely to occur and improve the releasability of the release agent.

In the release agent composition, when the amount of the polyester resin (A) blended is expressed as A parts by mass, and the amount of the acrylic-based polymer (B) blended is expressed as B parts by mass, the mass ratio A/B is in a range from 50/50 to 95/5. Regarding the mass ratio A/B, when the ratio of the polyester resin (A) is higher than the above-described range, the segregation of the acrylic polymer (B) on the release surface decreases, so that favorable releasability cannot be provided to the release agent. On the other hand, if the share of the acrylic polymer (B) is higher than indicated in the above-described range, the possibility of blocking is increased. The mass ratio A/B is preferably from 60/40 to 90/10 to obtain good releasability while reducing the possibility of blocking.

The cross-linking agent (C) is preferably a multifunctional amino compound, a multifunctional isocyanate compound, a multifunctional epoxy compound, or a multifunctional metal compound. The cross-linking agent (C) cures the release agent, for example, by reacting with the reactive functional group of the polyester resin (A) or the acrylic-based polymer (B) or the like to form a cured coating.

Examples of the multifunctional amino compound include melamine resins such as methylated melamine resins and butylated melamine resins; urea resins such as methylated urea resins and butylated urea resins; benzoguanamine resins such as methylated benzoguanamine resins and butylated benzoguanamine resins; diamines such as ethylenediamine, tetramethylenediamine, hexamethylenediamine, N,N′-diphenylethylenediamine, and p-xylylenediamine; and the like.

Examples of the multifunctional isocyanate compound include diphenylmethane diisocyanate (MDI), tolylene diisocyanate (TDI), hexamethylene diisocyanate (HDI), isophorone diisocyanate (IPDI), trimethylhexamethylene diisocyanate (TMDI), xylene diisocyanate (XDI), naphthalene diisocyanate (NDI), TDI-trimethylolpropane (TMP) adduct, HDI-TMP adduct, IPDI-TMP adduct, XDI-TMP adduct, and the like.

Examples of the multifunctional epoxy compound include N,N,N′,N′-tetraglycidyl-m-xylylenediamine, 1,3-bis(N,N-diglycidylaminomethyl)cyclohexane, and the like.

Examples of the multifunctional metal compound include aluminum chelate compounds such as aluminum tris(acetylacetonate) and aluminum ethylacetoacetate diisopropylate; titanium chelate compounds such as titanium tetraacetylacetonate, titanium acetylacetonate, titanium octyleneglycolate, tetraisopropoxytitanium, and tetramethoxytitanium; trimethoxyaluminum; and the like.

The amount of the cross-linking agent (C) blended is preferably 1 to 30 parts by mass relative to 100 parts by mass, which is the total amount of the polyester resin (A) and the acrylic-based polymer (B). Moreover, a known acidic catalyst such as hydrochloric acid or p-toluenesulfonic acid may optionally be added to the release agent composition.

Moreover, the release agent composition in this embodiment preferably contains substantially no silicone compound in order to not adversely affect electrical parts and the like. Note that the expression “contains substantially no silicone compound” means that the amount of the silicone compound is preferably 500 μg/g or less, and more preferably 100 μg/g or less.

A release sheet in one embodiment of the present invention includes a substrate and a release layer, which is formed on the substrate and made from a cured product of the release agent composition. The release layer is formed on the substrate by, for example, applying the release agent composition diluted with an organic solvent and/or the like onto a substrate, and then curing the release agent composition by thermal drying or the like.

Any commonly used substrate can be used as the substrate of the release sheet without any particular limitation. Examples of the substrate include resin films made of resins such as polypropylene, polyethylene terephthalate, polyethylene naphthalate, polybutylene terephthalate, polyimide, polyetherimide, polyetherketone, polyetheretherketone, polycarbonate, polymethyl methacrylate, triacetyl cellulose, and polynorbornene; papers such as woodfree paper, lint-free paper, glassine paper, clay-coated paper, resin-coated paper, and laminated papers (such as polyethylene-laminated paper and polypropylene-laminated paper); nonwoven fabrics; metal foils; and the like. Of these substrates, polyester films such as polyethylene terephthalate films are particularly preferable from the viewpoint of heat resistance, strength, adhesion to the release layer, and the like.

The thickness of the substrate varies among various applications, substrates, and the like. For example, when a resin film is used as the substrate, the thickness is generally 5 to 300 μm, and preferably about 20 to 200 μm. Meanwhile, when a paper substrate is used, the weight of the paper substrate per unit area is generally 20 to 450 g/m², and preferably about 40 to 220 g/m². The thickness of the release layer is, for example, 50 nm to 2 μm. When a resin film is used as the substrate, the thickness is preferably 50 to 300 nm. Meanwhile, when a paper substrate is used as the substrate, the thickness is preferably 0.3 μm to 2 μm.

A pressure-sensitive adhesive body in one embodiment of the present invention comprises the above-described release sheet and a pressure-sensitive adhesive layer, which is formed on the release layer of the release sheet and contains substantially no silicone compound. Here, the expression “contains substantially no silicone compound” means that trace amounts of the silicone compound preferably do not exceed 500 μg/m², and more preferably do not exceed 100 μg/m². Any non-silicone-based pressure-sensitive adhesive agent containing substantially no silicone compound can be used as a pressure-sensitive adhesive agent constituting the pressure-sensitive adhesive layer, without any particular limitation. For example, an acrylic-based pressure-sensitive adhesive agent or the like can be used. The pressure-sensitive adhesive layer is formed by applying the pressure-sensitive adhesive agent onto the release layer, followed by thermal drying. Moreover, the pressure-sensitive adhesive body may further comprise a backing, which is provided on the pressure-sensitive adhesive layer and supports the pressure-sensitive adhesive layer. The backing is not particularly limited, and any of the above-indicated examples of the substrate for the release sheet can be used. Note that, after being manufactured, the release sheet and the pressure-sensitive adhesive body are, for example, wound up into a rolled form for storage.

In this embodiment, the above-described constitution leads to the segregation of components, which originated from the acrylic-based polymer (B), near a surface (the release surface) of the release layer that was formed by curing the release agent composition. Presumably, such segregation occurs because the acrylic-based polymer (B) having different molecular structure, polarity, molecular weight, and the like from those of the polyester resin (A) is pushed up to the vicinity of the surface either during the curing of the release layer or at another time.

The acrylic-based polymer (B) exhibits sufficient mold releasability due to the segregation, and favorable releasability can be provided to the release layer even when only small amounts of acrylic-based polymer (B) are added, as in this embodiment. In addition, while the favorable releasability of the release layer is maintained by a small amount of the acrylic-based polymer (B), the anti-blocking performance is improved by relatively large amount of the polyester resin (A) blended in; furthermore, the adhesion to the substrate can also be improved.

Moreover, in this embodiment, the heat resistance of the release layer can also be improved by forming the release layer from the polyester resin (A) and the acrylic-based polymer (B). Hence, after the pressure-sensitive adhesive agent is directly applied onto the release layer, the pressure-sensitive adhesive layer can be formed by thermally drying the pressure-sensitive adhesive agent. And in applications involving electrical parts, the pressure-sensitive adhesive body and the release sheet do not adversely affect electrical parts and the like because the pressure-sensitive adhesive body and the release sheet are composed of non-silicone compounds.

Note that the number average molecular weight (Mn) and the mass average molecular weight (Mw) herein are values which are measured by gel permeation chromatography (GPC) under the following conditions in terms of polystyrene.

### (Measurement Conditions)

GPC measuring apparatus: HLC-8020 manufactured by Tosoh Corporation
GPC columns (passage in the following order): TSK guard column HXL-H, TSK gel GMHXL (×2), TSK gel G2000HXL (manufactured by Tosoh Corporation)
Solvent for measurement: tetrahydrofuran
Measuring temperature: 40° C.

Next, the present invention is described in further detail with specific examples. However, the present invention is not limited to the examples described below.

### Example 1

To a 1-liter flask equipped with a stirrer, a nitrogen inlet, a thermometer, and a condenser, 99 parts by mass of lauryl acrylate (LA), 1 part by mass of 2-hydroxyethyl acrylate (HEA), 0.2 parts by mass of azobisisobutyronitrile (AIBN), 100 parts by mass of toluene, and 100 parts by mass of ethyl acetate were added, and a polymerization reaction was carried out under a nitrogen stream at 80° C. for 2 hours. Thus, a solution (solid content: 30% by mass) of an LA-HEA copolymer (hereinafter referred to as “polymer A”) was obtained. The polymer A had a mass average molecular weight of 110,000. In addition, a polyester resin solution with a concentration of 35% by mass was prepared by dissolving a polyester resin (manufactured by Toyobo Co., Ltd., product name “VYLON 220”, number average molecular weight (Mn): 3000, hydroxyl value: 50 mgKOH/g) in toluene.

After 68 parts by mass (in terms of solid content) of the polyester resin solution, 32 parts by mass (in terms of solid content) of the solution of polymer A, 7 parts by mass (in terms of solid content) of a melamine resin (manufactured by Kotobukikakou Co., Ltd., product name “TF200”, solid content: 80% by mass) as a cross-linking agent, and 2115 parts by mass of a mixture solvent of toluene:methyl ethyl ketone (MEK)=30:70 (mass ratio) were mixed and stirred together, a catalyst composed of 2.8 parts by mass of a methanolic p-toluenesulfonic acid solution (containing 50% by mass of p-toluenesulfonic acid) was further added thereto, which was followed by stirring to produce coating liquid 1 having a solid content concentration of 2.5% by mass. A mayer bar was used to apply the coating liquid 1 to a polyethylene terephthalate (PET) film serving as a substrate and having a thickness of 50 μm, so that a thickness of 150 nm was achieved after drying. Then, the applied coating liquid 1 was cured by drying at 150° C. for 1 minute, and thereby a release layer was formed on the substrate. Thus, a release sheet comprising the substrate and the release layer was obtained.

### Example 2

A release sheet was obtained in the same manner as in Example 1, except that the release layer was formed by using coating liquid 2 (prepared to have a solid content concentration of 2.5% by mass) obtained by changing the formulation of coating liquid 1 such that the polyester resin solution was 81 parts by mass (in terms of solid content), the solution of polymer A was 19 parts by mass (in terms of solid content), and the melamine resin was 7 parts by mass (in terms of solid content).

### Example 3

A release sheet was obtained in the same manner as in Example 1, except that the release layer was formed by using coating liquid 3 (prepared to have a solid content concentration of 2.5% by mass) obtained by changing the formulation of coating liquid 1 such that the polyester resin solution was 90 parts by mass (in terms of solid content), the solution of polymer A was 10 parts by mass (in terms of solid content), and the melamine resin was 7 parts by mass (in terms of solid content).

### Example 4

To a 1-liter flask equipped with a stirrer, a nitrogen inlet, a thermometer, and a condenser, 97 parts by mass of LA, 3 parts by mass of HEA, 0.2 parts by mass of AIBN, 100 parts by mass of toluene, and 100 parts by mass of ethyl acetate were added, and a polymerization reaction was carried out under a nitrogen stream at 80° C. for 2 hours. Thus, a solution (solid content: 30% by mass) of an LA-HEA copolymer (hereinafter referred to as “polymer B”) was obtained. The polymer B had a mass average molecular weight of 110,000. Then, a release sheet was obtained in the same manner as in Example 1, except that the release layer was formed by using coating liquid 4, which was obtained by changing the formulation of coating liquid 1 such that the solution of polymer A was replaced with the solution of polymer B.

### Example 5

To a 1-liter flask equipped with a stirrer, a nitrogen inlet, a thermometer, and a condenser, 90 parts by mass of LA, 10 parts by mass of HEA, 0.2 parts by mass of AIBN, 100 parts by mass of toluene, and 100 parts by mass of ethyl acetate were added, and a polymerization reaction was carried out under a nitrogen stream at 80° C. for 2 hours. Thus, a solution (solid content: 30% by mass) of an LA-HEA copolymer (hereinafter referred to as “polymer C”) was obtained. The obtained polymer C had a mass average molecular weight of 111,000. Then, a release sheet was obtained in the same manner as in Example 1, except that the release layer was formed by using coating liquid 5, which was obtained by changing the formulation of the coating liquid such that the solution of polymer A was replaced with the solution of polymer C.

### Example 6

To a 1-liter flask equipped with a stirrer, a nitrogen inlet, a thermometer, and a condenser, 99 parts by mass of myristyl acrylate (MyA), 1 part by mass of HEA, 0.2 parts by mass of AIBN, 100 parts by mass of toluene, and 100 parts by mass of ethyl acetate were added, and a polymerization reaction was carried out under a nitrogen stream at 80° C. for 2 hours. Thus, a solution (solid content 30%: by mass) of a MyA-HEA copolymer (hereinafter referred to as “polymer D”) was obtained. The polymer D had a mass average molecular weight of 140,000. Then, a release sheet was obtained in the same manner as in Example 1, except that the release layer was formed by using coating liquid 6, which was obtained by changing the formulation of coating liquid 1 such that the solution of polymer A was replaced with the solution of polymer D.

### Example 7

To a 1-liter flask equipped with a stirrer, a nitrogen inlet, a thermometer, and a condenser, 99 parts by mass of LA, 1 part by mass of HEA, 0.073 parts by mass of AIBN, 100 parts by mass of toluene, and 100 parts by mass of ethyl acetate were added, and a polymerization reaction was carried out under a nitrogen stream at 70° C. for 5 hours. Thus, a solution (solid content: 30% by mass) of an LA-HEA copolymer (hereinafter referred to as “polymer E”) was obtained. The polymer E had a mass average molecular weight of 400,000. Then, a release sheet was obtained in the same manner as in Example 1, except that the release layer was formed by using coating liquid 7, which was obtained by changing the formulation of coating liquid 1 such that the solution of polymer A was replaced with the solution of polymer E.

### Example 8

To a 1-liter flask equipped with a stirrer, a nitrogen inlet, a thermometer, and a condenser, 99 parts by mass of LA, 1 part by mass of HEA, 0.2 parts by mass of AIBN, and 100 parts by mass of ethyl acetate were added, and a polymerization reaction was carried out under a nitrogen stream at 80° C. for 18 hours. Thus, a solution (solid content: 30% by mass) of an LA-HEA copolymer (hereinafter referred to as “polymer F”) was obtained. The polymer F had a mass average molecular weight of 870,000. Then, a release sheet was obtained in the same manner as in Example 1, except that the release layer was formed by using coating liquid 8, which was obtained by changing the formulation of coating liquid 1 such that the solution of polymer A was replaced with the solution of polymer F.

### Example 9

To a 1-liter flask equipped with a stirrer, a nitrogen inlet, a thermometer, and a condenser, 99 parts by mass of LA, 1 part by mass of 4-hydroxybutyl acrylate (4HBA), 0.073 parts by mass of AIBN, 100 parts by mass of toluene, and 100 parts by mass of ethyl acetate were added, and a polymerization reaction was carried out under a nitrogen stream at 80° C. for 2 hours. Thus, a solution (solid content: 30% by mass) of an LA-4HBA copolymer (hereinafter referred to as “polymer G”) was obtained. The polymer G had a mass average molecular weight of 130,000. Then, a release sheet was obtained in the same manner as in Example 1, except that the release layer was formed by using coating liquid 9, which was obtained by changing the formulation of coating liquid 1 such that the solution of polymer A was replaced with the solution of polymer G.

### Example 10

To a 1-liter flask equipped with a stirrer, a nitrogen inlet, a thermometer, and a condenser, 99 parts by mass of MyA, 1 part by mass of 4HBA, 0.063 parts by mass of AIBN, and 200 parts by mass of ethyl acetate were added, and a polymerization reaction was carried out under a nitrogen stream at 80° C. for 2 hours. Thus, a solution (solid content: 30% by mass) of an MyA-4HBA copolymer (hereinafter referred to as “polymer H”) was obtained. The polymer H had a mass average molecular weight of 210,000. Then, a release sheet was obtained in the same manner as in Example 1, except that the release layer was formed by using coating liquid 10, which was obtained by changing the formulation of coating liquid 1 such that the solution of polymer A was replaced with the solution of polymer H.

### Example 11

To a 1-liter flask equipped with a stirrer, a nitrogen inlet, a thermometer, and a condenser, 99 parts by mass of MyA, 1 part by mass of HEA, 0.09 parts by mass of AIBN, 100 parts by mass of toluene, and 100 parts by mass of ethyl acetate were added, and a polymerization reaction was carried out under a nitrogen stream at 80° C. for 2 hours. Thus, a solution (solid content: 30% by mass) of an MyA-HEA copolymer (hereinafter referred to as “polymer I”) was obtained. The polymer I had a mass average molecular weight of 270,000. Then, a release sheet was obtained in the same manner as in Example 1, except that the release layer was formed by using coating liquid 11, which was obtained by changing the formulation of coating liquid 1 such that the solution of polymer A was replaced with the solution of polymer I.

### Example 12

To a 1-liter flask equipped with a stirrer, a nitrogen inlet, a thermometer, and a condenser, 99 parts by mass of MyA, 1 part by mass of HEA, 0.063 parts by mass of AIBN, and 200 parts by mass of ethyl acetate were added, and a polymerization reaction was carried out under a nitrogen stream at 80° C. for 2 hours. Thus, a solution (solid content: 30% by mass) of an MyA-HEA copolymer (hereinafter referred to as “polymer J”) was obtained. The polymer J had a mass average molecular weight of 480,000. Then, a release sheet was obtained in the same manner as in Example 1, except that the release layer was formed by using coating liquid 12, which was obtained by changing the formulation of coating liquid 1 such that the solution of polymer A was replaced with the solution of polymer J.

### Example 13

A release sheet was obtained in the same manner as in Example 1, except that the release layer was formed by using coating liquid 13 (prepared to have a solid content concentration of 2.5% by mass) obtained by changing the formulation of coating liquid 1 such that the polyester resin solution was 65 parts by mass (in terms of solid content), the solution of polymer A was 35 parts by mass (in terms of solid content), and the melamine resin was 16 parts by mass (in terms of solid content).

### Example 14

A release sheet was obtained in the same manner as in Example 1, except that the release layer was formed by using coating liquid 14 (prepared to have a solid content concentration of 2.5% by mass) obtained by changing the formulation of coating liquid 1 such that the polyester resin solution was 65 parts by mass (in terms of solid content), the solution of polymer D was 35 parts by mass (in terms of solid content), and the melamine resin was 16 parts by mass (in terms of solid content).

### Comparative Example 1

A release sheet was obtained in the same manner as in Example 1, except that the release layer was formed by using coating liquid 9 (prepared to have a solid content concentration of 2.5% by mass) obtained by changing the formulation of coating liquid 1 such that the polyester resin solution was 46 parts by mass (in terms of solid content), the solution of polymer A was 54 parts by mass (in terms of solid content), and the melamine resin was 7 parts by mass (in terms of solid content).

### Comparative Example 2

A release sheet was obtained in the same manner as in Example 1, except that the release layer was formed by using coating liquid 10 (prepared to have a solid content concentration of 2.5% by mass) obtained by changing the formulation of coating liquid 1 such that the polyester resin solution was 99 parts by mass (in terms of solid content), the solution of polymer A was 1 part by mass (in terms of solid content), and the melamine resin was 7 parts by mass (in terms of solid content).

### Comparative Example 3

To a 1-liter flask equipped with a stirrer, a nitrogen inlet, a thermometer, and a condenser, 99 parts by mass of stearyl acrylate (StA), 1 part by mass of HEA, 0.2 parts by mass of AIBN, and 100 parts by mass of toluene were added, and a polymerization reaction was carried out under a nitrogen stream at 80° C. for 2 hours. Thus, a solution (solid content: 50% by mass) of an StA-HEA copolymer (hereinafter referred to as “polymer G”) was obtained. The polymer G had a mass average molecular weight or 100,000. Then, a release sheet was obtained in the same manner as in Example 1, except that the release layer was formed by using coating liquid 11 (prepared to have a solid content concentration of 2.5% by mass), which was obtained by changing the formulation of coating liquid 1 such that the solution of polymer A was replaced with the solution of polymer G.

### [Fabrication of Pressure-Sensitive Adhesive Body]

An acrylic-based pressure-sensitive adhesive agent (manufactured by Toyo Ink Mfg. Co., Limited, product name “Oribain BPS-5127” was applied to the release layer of each of the release sheets obtained from the Examples and Comparative Examples by using an applicator, and then dried by heating at 100° C. for 120 seconds. Thus, a pressure-sensitive adhesive layer having a thickness of 25 μm was formed. Subsequently, a backing for the pressure-sensitive adhesive layer composed of a pressure-sensitive adhesive body was obtained by attaching a polyethylene terephthalate film having an average thickness of 50 μm.

### [Evaluation Method]

### [Release Force Measurement]

The release force of the release sheet of each of the pressure-sensitive adhesive bodies obtained by using the release sheets of the Examples and Comparative Examples was measured according to JIS-Z0237 as follows. Specifically, a piece having a width of 20 mm and a length of 200 mm was cut from each pressure-sensitive adhesive body. Then, while the piece of the pressure-sensitive adhesive sheet comprising the backing and the pressure-sensitive adhesive body was held in place, the release sheet was pulled in the direction of 180° at a rate of 300 mm/minute by using a tensile tester. Thus, the release force was measured.

### [Evaluation of Anti-Blocking Property]

Two sections having a width of 20 mm and a length of 18 cm were cut from each of the release sheets obtained in the Examples and Comparative Examples and stacked on top of one another but slightly offset by 3 cm from each other in the lengthwise direction, with a surface of the release layer and a surface of the substrate being in contact with each other. Next, the two stacked release sheets were allowed to stand under an environment of 60° C. for 24 hours, with a load of 100 g/cm² being applied to the two release sheets. Afterward, one of the two release sheets was fixed and the other release sheet was pulled with a tensile tester in the opposite direction at a rate of 60 mm/minute. In this manner, the shearing force required for peeling off the release sheet was measured and evaluated based on the following three criteria.

A: The shearing force required for peeling away was smaller than 1 N/m², and was at a level where a smooth release was possible.

B: The shearing force required for peeling away was greater or equal than 1 N/m² but less than 5 N/m², and was at a level where no problem would be caused in practical use, although a slight amount of blocking was observed.

C: The shearing force required for peeling away was 5 N/m² or higher, and was at a level where substantial blocking was observed.

### [Formulation Table]

TABLE 1

| | |
|---|---|
| | Cross-linking |
| Polyester | agent (C) |

| | resin (A) | Acrylic-based polymer (B) | | | (melamine resin) |
|---|---|---|---|---|---|
| | Blended amount | | Molecular weight | Blended amount | Blended amount |
| | (Part by mass) | Constitution | (Mw) | (Part by mass) | (Part by mass) |
| Example 1 | 68 | LA/HEA = 99/1 | 110000 | 32 | 7 |
| Example 2 | 81 | LA/HEA = 99/1 | 110000 | 19 | 7 |
| Example 3 | 90 | LA/HEA = 99/1 | 110000 | 10 | 7 |
| Example 4 | 68 | LA/HEA = 97/3 | 110000 | 32 | 7 |
| Example 5 | 68 | LA/HEA = 90/10 | 111000 | 32 | 7 |
| Example 6 | 68 | MyA/HEA = 99/1 | 140000 | 32 | 7 |
| Example 7 | 68 | LA/HEA = 99/1 | 400000 | 32 | 7 |
| Example 8 | 68 | LA/HEA = 99/1 | 870000 | 32 | 7 |
| Example 9 | 68 | LA/4HBA = 99/1 | 130000 | 32 | 7 |
| Example 10 | 68 | MyA/4HBA = 99/1 | 210000 | 32 | 7 |
| Example 11 | 68 | MyA/HEA = 99/1 | 270000 | 32 | 7 |
| Example 12 | 68 | MyA/HEA = 99/1 | 480000 | 32 | 7 |
| Example 13 | 65 | LA/HEA = 99/1 | 110000 | 35 | 16 |
| Example 14 | 65 | MyA/HEA = 99/1 | 140000 | 35 | 16 |
| Comp. Ex. 1 | 46 | LA/HEA = 99/1 | 110000 | 54 | 7 |
| Comp. Ex. 2 | 99 | LA/HEA = 99/1 | 110000 | 1 | 7 |
| Comp. Ex. 3 | 68 | StA/HEA = 99/1 | 100000 | 32 | 7 |

### [Evaluation Results]

TABLE 2

| | Release force | Anti-blocking |
|---|---|---|
| | (mN/20 mm) | property |
| Example 1 | 110 | A |
| Example 2 | 120 | A |
| Example 3 | 190 | A |
| Example 4 | 190 | A |
| Example 5 | 680 | A |
| Example 6 | 160 | A |
| Example 7 | 130 | A |
| Example 8 | 150 | A |
| Example 9 | 140 | A |
| Example 10 | 160 | A |
| Example 11 | 120 | A |
| Example 12 | 160 | A |
| Example 13 | 180 | A |
| Example 14 | 260 | A |
| Comp. Ex. 1 | 130 | C |
| Comp. Ex. 2 | Cohesive failure of | A |
| | pressure-sensitive | |
| | adhesive layer due | |
| | to release failure | |
| Comp. Ex. 3 | 2000 | A |

As described above, the release sheets of Examples 1 to 14 of the present invention displayed excellent anti-blocking properties and favorable releasability characteristics. On the other hand, when the amount of the acrylic polymer blended in the release agent was increased or decreased to an excessive amount in Comparative Examples 1 and 2, the result was poor-quality release sheets plagued by blocking problems and release failures. In addition, since the acrylic-based polymer (B) of Comparative Example 3 had an alkyl group having more than 16 carbon atoms, it caused the release force to increase so much that the release sheet was left with poor releasability.

1. A release agent composition comprising:
a polyester resin (A);
an acrylic-based polymer (B) containing a constitutional unit represented by the following general formula (1); and
a cross-linking agent (C); wherein
when the amount of the polyester resin (A) blended is expressed as A parts by mass, and the amount of the acrylic-based polymer (B) blended is expressed as B parts by mass, the mass ratio A/B is in a range from 50/50 to 95/5: 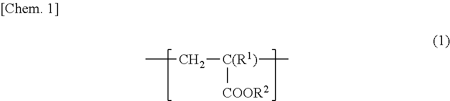
(in general formula (1), R¹ represents a hydrogen atom or a methyl group, and R² represents an alkyl group having 12 to 16 carbon atoms).

2. The release agent composition according to claim 1, wherein
the acrylic-based polymer (B) further contains a constitutional unit having a functional group selected from the group consisting of a hydroxyl group, an amino group, and a carboxyl group.

3. The release agent composition according to claim 1, wherein
the polyester resin (A) has a number average molecular weight of 500 to 10,000.

4. The release agent composition according to claim 1, wherein
the acrylic-based polymer (B) has a mass average molecular weight of 70,000 to 2 million.

5. The release agent composition according to claim 1, wherein
the polyester resin (A) has a hydroxyl group as a functional group.

6. The release agent composition according to claim 1, wherein
the cross-linking agent (C) is a multifunctional amino compound, a multifunctional isocyanate compound, a multifunctional epoxy compound, or a multifunctional metal compound.

7. The release agent composition according to claim 1, wherein
the amount of the cross-linking agent (C) blended is 1 to 30 parts by mass relative to 100 parts by mass, which is the total amount of the polyester resin (A) and the acrylic-based polymer (B).

8. The release agent composition according to any one of claims 1 to 7, which contains substantially no silicone compound.

9. A release sheet comprising:
a substrate; and
a release layer which is provided on the substrate, and which is made of a cured product of the release agent composition according to claim 1.

10. The release sheet according to claim 9, wherein
the release layer has a thickness of 50 nm to 2 μm.

11. A pressure-sensitive adhesive body comprising:
the release sheet according to claim 9 or 10; and
a pressure-sensitive adhesive layer, which is provided on the release layer of the release sheet and contains substantially no silicone compound.
